(19) United States
(12) Patent Application Publication
(10) Pub. No.: US 2016/0257612 A1
(43) Pub. Date: Sep. 8, 2016

(54) COATING OF BAIT SUBSTRATES FOR OPTICAL FIBER MAKING

(71) Applicant: Corning Incorporated, Corning, NY (US)

(72) Inventors: Liam Ruan de Paor, Hampstead, NC (US); Nicolas LeBlond, Painted Post, NY (US); Richard Curwood Peterson, Elmira Heights, NY (US); Kenneth William Roberts, Wilmington, NC (US); Li Yang, Horseheads, NY (US)

(21) Appl. No.: 15/049,359

(22) Filed: Feb. 22, 2016

Related U.S. Application Data
(60) Provisional application No. 62/128,087, filed on Mar. 4, 2015.

(51) Int. Cl. C03C 25/10

(52) U.S. Cl. CPC C03C 25/10

(57) ABSTRACT

A method for forming a porous soot body that includes depositing soot on a release coating supported by a bait substrate. Characteristics of the release coating control the strength of attachment of the porous soot body to the bait substrate. Weak attachment of the porous soot body to the bait substrate facilitates separation of the porous soot body from the bait substrate without damaging the porous soot body. The release coating may be formed from a brittle material or a material that oxidizes or otherwise depletes during deposition of the soot that forms the porous soot body. The release coating may include carbon. The separated porous soot body may be consolidated to form a core cane or may function as a sleeve (porous cladding) in a cane-in-soot fiber preform manufacturing process.

This application claims the benefit of priority under 35 U.S.C. §119 of U.S. Provisional Application Ser. No. 62/128,087 filed on Mar. 4, 2015 the content of which is relied upon and incorporated herein by reference in its entirety.

### FIELD

This description pertains to methods of applying carbon coatings to bait substrates used in the production of optical fibers. This description also pertains to carbon coating formulations adapted for use in optical fiber production.

### BACKGROUND

The production of optical fibers often utilizes an outside vapor deposition (OVD) process in which soot is deposited on a bait substrate to form a porous glass body that is subsequently consolidated to form a densified glass. A depiction of soot deposition by the OVD process is shown in FIG. 1. In the OVD process, a bait substrate 30 (e.g. a bait rod) with centerline 28 is inserted through a glass body such as hollow or tubular handle 32 and mounted on a lathe (not shown). The lathe is designed to rotate and translate bait substrate 30 in close proximity with a soot-generating burner 34. Soot-generating burner 34 forms silica-based soot 36 by reacting one or more precursors (e.g. SiCl₄, octamethylcyclotetrasiloxane, GeCl₄, TiCl₄, Ti alkoxides etc.) in a flame hydrolysis or oxidation process. As bait substrate 30 is rotated, the silica-based soot 36 is directed toward bait substrate 30. At least a portion of silica-based soot 36 is deposited on bait substrate 30 and on a portion of handle 32. Through relative translational motion of bait substrate 30 and burner 34, silica-based soot 36 accumulates on bait substrate 34 to form porous soot body 20. Once the desired quantity of soot has been deposited on bait substrate 30, soot deposition is terminated, bait substrate 30 is removed from porous soot body 20 to provide an annular preform having an internal cavity.

The annular preform can be further processed to form a core cane or can be used as a sleeve in a cane-in-soot or rod-in-cylinder process. When forming a core cane, the annular preform is dehydrated and consolidated to form a densified glass that serves as a glass core portion upon which cladding may be deposited to form an optical fiber preform. In the cane-in-soot or rod-in-cylinder process, the annular preform represents the cladding portion of an optical fiber preform. The optical fiber preform is formed by inserting a consolidated core cane in the internal cavity of the annular preform and consolidating the assembly. In the rod-in-cylinder process, the annular preform is typically drawn to a particular size (“tube”) before inserting the core cane and in the cane-in-soot process, the annular preform is used directly without intermediate processing to form the tube. Consolidation densifies the annular preform and fuses it with the core cane to form the optical fiber preform.

One of the difficulties of the fiber production process is separation of bait substrate 30 from porous soot body 20. Porous soot body 20 is often damaged when bait substrate 30 is removed and process yields are accordingly reduced. One strategy for minimizing damage to porous soot body 20 upon removal of bait substrate 30 is to coat bait substrate 30 with a release agent that acts to facilitate separation of porous soot body 20 from bait substrate 30. Carbon soot is a common release agent and can be formed by supplying a carbon-containing gas to a burner and partially combusting it. The carbon soot is deposited on the bait substrate prior to deposition of the silica-based soot used to form porous soot body 20. The carbon soot constitutes a sacrificial layer that prevents adhesion of the silica-based soot on bait substrate 30. During formation of porous soot body 20, the sacrificial carbon layer is progressively oxidized and vaporized to create a narrow gap between bait substrate 30 and porous soot body 20. The narrow gap facilitates removal of bait substrate 30 from porous soot body 20.

Acetylene is a common carbon-containing gas that is used to form the sacrificial carbon layer. Acetylene offers the advantage of high deposition rates, but suffers from several drawbacks. Combustion of acetylene is difficult to control, the purity and energy content of acetylene feedstocks are variable and inconsistent, specialized burner designs are needed, and the carbon soot formed from acetylene is often sufficiently coarse that the resulting sacrificial carbon layer has low mechanical strength and has a tendency to prematurely separate from bait substrate 30 during deposition of the silica-based soot during formation of porous soot body 20. Methane is an alternative to acetylene that is easier to control. Methane feedstocks are also high in purity and can be combusted with the same burners used to form the silica-based soot. Carbon soot formed from methane is also much finer than the soot formed from acetylene and produces sacrificial carbon layers that are more durable. The main drawback to methane is a slow deposition rate. The time needed to form sacrificial carbon layers from methane represents a significant fraction of the overall process time needed to form porous soot body 20.

Processes in which the sacrificial carbon layer is formed in situ on the bait substrate immediately before the deposition of the silica-based soot are disadvantageous in situations in which it is desirable to collect unutilized silica-based soot. In a typical OVD process, a significant fraction of the silica-based soot generated by the burner(s) is not deposited on the bait substrate and remains in the overhead space instead. The unutilized silica-based soot is ultimately vented through exhaust ports of the deposition system. To improve process efficiency, it is desirable to recover the unutilized silica-based soot and to recycle it or use it for other purposes. Silica-based soot, for example, can be used in the manufacture of glazing for tiles. When the sacrificial carbon layer is formed in situ during deposition of the silica-based soot, carbon impurities can form in the system and exhaust vents. The presence of carbon in the system leads to carbon contamination of unutilized silica-based soot recovered from the system and renders the recovered silica-based soot insufficiently pure for many alternative applications. It is therefore desirable to develop a process for forming sacrificial carbon layers on bait substrates during optical fiber fabrication without compromising the purity of unutilized silica-based soot recovered from the system.

### SUMMARY

The present description provides a method for forming a porous soot body on bait substrates used in the production of optical fibers. The method includes forming a release coating on the bait substrate and forming a porous soot body on the release coating. The release coating is a sacrificial layer formed on the surface of the bait substrate. The presence of the release coating facilitates separation of the bait substrate from the porous soot body. The separated porous soot body may subsequently be consolidated to form a core cane. Alternatively, the porous soot body may be integrated with a core cane to form a core-cladding assembly that can be consolidated to form a fiber preform.

The release coating may include or consist essentially of carbon. The carbon may be in the form of carbon particles or carbon-containing particles. The thickness of the release coating may be in the range from 1-250 μm, or 5-200 μm, or 10-200 μm, or 10-150 μm, or 15-100 μm, or 20-80 μm.

The release coating may be formed from a coating formulation that includes a carbon precursor, a binder, and a solvent. The carbon precursor may be graphite or carbon black. The carbon precursor may include carbon particles or carbon-containing particles. The average particle size of the carbon particles or carbon-containing particles may be in the range from 0.1-50 μm, or 1-50 μm, or 2-25 μm, or 5-20 μm, or 10-100 nm, or 25-75 nm, or 40-60 nm, or 10-1000 nm, or 20-500 nm, or 50-250 nm, or less than 2 μm, or less than 1 μm, or less than 500 nm. In one embodiment, the carbon precursor is graphite having an average particle size of 0.1-50 μm, or 1-50 μm, or 2-25 μm, or 5-20 μm. In another embodiment, the carbon precursor is carbon black having an average particle size of less than 2 μm, or less than 1 μm, or less than 500 nm, or in the range from 10-100 nm, or 25-75 nm, or 40-60 nm, or 10-1000 nm, or 20-500 nm, or 50-250 nm.

The binder may be a cellulose-based binder. The cellulose-based binder may include an alkylated or alkoxylated cellulose compound. In one embodiment, the binder is ethylcellulose. The solvent may be an alcohol. The coating formulation may optionally include a co-solvent. The co-solvent may be an alcohol. In one embodiment, the solvent is isopropanol. In another embodiment, the solvent is isopropanol and the coating formulation includes a co-solvent, where the co-solvent is butanol or 1-methoxy-2-propanol.

The ratio (in wt %) of carbon precursor to binder in the coating formulation may be at least 5:1, or at least 10:1, or at least 15:1, or at least 20:1.

In one embodiment, the coating formulation includes 5-30 wt % carbon precursor, 0.10-2.0 wt % binder, and 50-95 wt % solvent or combined solvent and co-solvent. In another embodiment, the coating formulation includes 5-30 wt % graphite and/or carbon black, 0.10-2.0 wt % cellulose-based binder, and 50-95 wt % combined solvent and co-solvent.

The release coating may be formed by a variety of processes, including pyrolytic decomposition, dip coating, and spray coating.

The release coating and silica soot may be formed in different deposition systems. Forming the release coating on the bait substrate in a separate deposition system prevents contamination of the deposition system used to deposit soot on the release coating and permits recovery of unutilized soot generated in the soot deposition process in a state free from contamination by the release coating or precursors used to form the release coating. The recovered unutilized soot may be recycled or used for other purposes.

The present disclosure extends to:

A method for forming a porous soot body comprising:

placing a bait substrate in a first deposition system;

forming a release coating on said bait substrate;

transferring said coated bait substrate from said first deposition system to a second deposition system; and

depositing soot on said coated bait substrate in said second deposition system.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings are illustrative of selected aspects of the present description, and together with the specification serve to explain principles and operation of methods, products, and compositions embraced by the present description. Features shown in the drawing are illustrative of selected embodiments of the present description and are not necessarily depicted in proper scale.

### BRIEF DESCRIPTION OF THE DRAWINGS

While the specification concludes with claims particularly pointing out and distinctly claiming the subject matter of the written description, it is believed that the specification will be better understood from the following written description when taken in conjunction with the accompanying drawings, wherein:

FIG. 1 depicts deposition of soot onto a bait substrate using an OVD process.

FIG. 2 depicts an alumina bait rod coated with a pyrolytic carbon release coating.

FIG. 3 depicts a dip coating apparatus for applying a release coating.

FIG. 4 illustrates factors that influence the thickness of release coating and withdrawal speed of the bait substrate in a dip coating process.

FIG. 5 illustrates carbon release coatings on alumina bait rods.

FIG. 6 illustrates carbon release coatings on alumina bait rods.

The embodiments set forth in the drawings are illustrative in nature and not intended to be limiting of the scope of the detailed description or claims. Whenever possible, the same reference numeral will be used throughout the drawings to refer to the same or like feature.

### DETAILED DESCRIPTION

Reference will now be made in detail to illustrative embodiments. The present description provides a method for providing a release coating on bait substrates used in the production of optical fibers. The release coating is a sacrificial layer formed on the surface of the bait substrate. A porous soot body is formed on the release coating and the presence of the release coating facilitates separation of the bait substrate from the porous soot body. Inclusion of an intervening release coating between the bait substrate and porous soot body enables removal of the porous soot body from the bait substrate with minimal damage to the porous soot body. Instead of adhering to or otherwise interacting strongly with the bait substrate, the porous soot body associates weakly with the release coating and can be readily extracted from the bait substrate with minimal mechanical force.

The bait substrate provides a receiving surface for the deposition of soot. The bait substrate may be planar, cylindrical, or other arbitrary shape. In one embodiment, the bait substrate is a bait rod having a generally cylindrical shape. In another embodiment, the bait substrate may be tapered. The bait substrate may be a metal, a metal alloy, or a ceramic. In one embodiment, the bait substrate is a metal oxide such as alumina.

The release coating is a coating formed on the surface of the bait substrate. The outer surface of the release coating serves as a receiving surface for subsequent deposition of soot. In one embodiment, the release coating is a brittle material that fractures readily upon application of mechanical force to the bait substrate during removal of the bait substrate from the porous soot body. Fracture of the release coating severs the link between the bait substrate and porous soot body and allows for easy separation of the porous soot body from the bait substrate. The separated porous soot body is recovered intact with little or no damage.

In another embodiment, the release coating is an oxidizable, decomposable, or otherwise reactive material that progressively degrades or is progressively removed during deposition of the porous soot body to form a gap between the bait substrate and porous soot body that reduces the strength of interaction between the porous soot body and the bait substrate. In this embodiment, the release coating is intact in the initial stages of deposition of porous soot and an initial layer of porous soot forms on the release coating. As the thickness of porous soot layer increases, its mechanical integrity improves and it becomes sufficiently strong to support continued deposition of porous soot to permit formation of a porous soot body having a desired thickness. At the same time, the conditions under which the porous soot is formed and deposited lead to oxidation, reaction or other mechanism of depletion of the release coating. As the release coating is depleted, it becomes thinner or more porous and its capacity to mechanically join the porous soot body to the bait substrate is impaired. In one embodiment, a gap develops between the porous soot body and the bait substrate at one or more positions along the length of the bait substrate. As gaps and/or porosity develop in the release coating, the mechanical strength of the release coating also decreases and the release coating becomes amenable to fracture with less force to facilitate separation of the porous soot body from the bait substrate.

The release coating may be a dense coating on the surface of the bait substrate. Alternatively the release coating may be a porous coating on the surface of the bait substrate. In one embodiment, the release coating is a soot or soot-containing material. In another embodiment, the release coating is a particulate or nano-particulate material.

In one embodiment, the release coating is a carbon-containing material. Carbon-containing materials are readily oxidized and may be progressively depleted under the conditions at which the porous soot body is formed. The carbon-containing material may be a carbon-containing soot or a carbon-containing particulate or nanoparticle material. In another embodiment, the release coating is a material that consists essentially of carbon. An essentially pure carbon material is advantageous because it essentially lacks other elements that may remain as impurities on the surface of or within the porous soot body upon depletion of the release coating and/or separation of the bait substrate from the porous soot body.

The thickness of the release coating is adjusted to provide an effective barrier between the bait substrate and porous soot body to facilitate separation of the bait substrate from the porous soot body. The thickness of the release coating may be in the range from 1-250 μm, or 5-200 μm, or 10-200 μm, or 10-150 μm, or 15-100 μm, or 20-80 μm.

To prevent contamination of the apparatus in which soot deposition occurs with precursors used to form the release coating, it is preferable to form the release coating in a separate system. Once the release coating is formed on the bait substrate, the coated bait substrate can be placed in the soot deposition apparatus and soot can be formed on the release coating. By avoiding contamination of the soot deposition apparatus with precursors used to form the release coating or byproducts produced during formation of the release coating, the purity of unutilized soot recovered from the soot deposition process is higher and the unutilized soot is suitable for use in a wider range of applications. A process in which the release coating is formed separate from the system used to deposit soot may be referred to herein as an offline process.

In one embodiment, the release coating is formed on the bait substrate by a pyrolytic deposition technique. In pyrolytic deposition, a precursor (usually a gas) is heated to near its decomposition temperature to release one or more elements that deposit on the surface of the bait substrate to form the release coating. Chemical vapor deposition (CVD) is one example of a pyrolytic deposition technique. To deposit a carbon release coating, a hydrocarbon gas (e.g., methane, acetylene, propane, butane, 1,3-butadiene) is heated to near its decomposition temperature (typically above 1000° C.) to induce conversion to carbon and hydrogen. The hydrogen exits the process as a gas (H₂) and the carbon deposits onto the surface of the bait substrate where it forms a coating. Process conditions can be varied to control the porosity of the coating. Dense coatings can also be formed. Multiple precursors may be pyrolyzed simultaneously or in series to provide release coatings having multiple elements. If decomposition is limited to a hydrocarbon gas, the resulting release coating consists essentially of carbon.

In another embodiment, the release coating is formed by a dip coating process. In dip coating, the bait substrate is immersed into a precursor consisting of a solution or a suspension of the coating material in a liquid medium (solvent or suspension medium) and then withdrawn. The coating forms on the bait substrate as the liquid medium evaporates. The thickness of the coating is determined by the viscosity of the liquid medium, the withdrawal speed, and the evaporation rate. To form a carbon release coating in one embodiment, the precursor includes a suspension of high-purity graphite or carbon black powder in an isopropanol-based solvent. A binder (e.g. ethyl cellulose) may optionally be present in the suspension.

In still another embodiment, the release coating is formed by a spray coating process. In the spray coating process, a gas- (e.g. air-) driven spray coating delivery system is used to deliver a liquid coating material (e.g. a solution of the coating material in a solvent or a suspension of the coating material in a suspension medium) in the form of a mist or aerosol to the bait substrate. The bait substrate is rotated as the spray head is translated back and forth along the target coating length of the bait substrate while the spraying head is delivering a pre-determined aerosol flow rate. Ideally, the coating formulation is such that the solvent or suspension medium quickly evaporates between spraying passes to minimize drip formation or other undesired coating non-uniformities. The thickness, density, and uniformity of the resulting release coating is a function of the loading of the coating formulation with the coating material, the pressure/flow rate of the gas creating the aerosol, the rotation speed of the bait rod, the translation speed of the spraying head, and the number of passes. The coating thickness can range from <25 μm to 250 μm. The spraying process permits a range of deposition profiles for the release coating onto the bait substrate. By varying process parameters a release coating of uniform thickness can be deposited on the bait substrate. Alternatively, a release coating having a tapered or undulating thickness profile along the length of the bait substrate can be formed. The coating formulation may include carbon or a carbon-containing material in a solvent or suspension medium. The coating formulation may be a carbon-based ink formulation.

The porous soot body is formed by depositing soot on to the release coating. In one embodiment, the soot is silica soot. The silica soot may be doped. In another embodiment, the soot includes a silica-containing soot, such as a soot with oxide particles that include silicon and one or more additional elements (e.g. Ti). In still another embodiment, the soot is a mixture of silica soot with oxide soot derived from one or more non-silicon elements (e.g. a combination of silica soot and titania soot, or a combination of silica soot and germania soot).

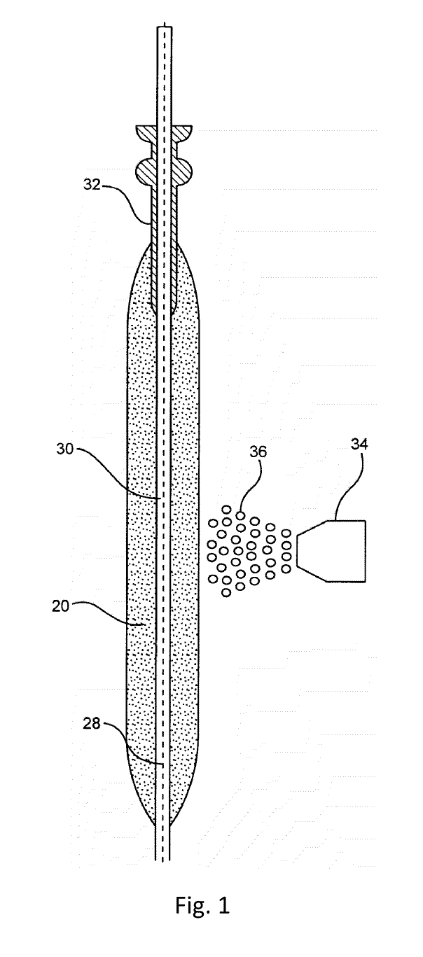

A number of soot deposition techniques are known in the art. For example, the soot can be generated using one or more burners in a flame process. Flame processes include delivery of one or more soot precursors to the one or more burners and combustion or reaction of the one or more soot precursors in flames produced by the burners. Representative flame processes include flame hydrolysis and flame oxidation. Flame processes include outside vapor deposition (OVD) (see FIG. 1) and vapor axial deposition (VAD). Precursors for silicon in flame processes include SiCl₄ and octamethylcyclo-tetrasiloxane (OMCTS). Precursors for metal oxide soots include metal chlorides (e.g. TiCl₄) and metal alkoxides (e.g. Ti(i-OPr)₄). The soot generated by the flame process is particulate in nature and accumulates on the release coating to form a porous soot body. The bait substrate with release coating can be equipped with a handle and mounted in a lathe that provides rotational and translation motion of the bait substrate. The one or more burners may be configured in a movable assembly that permits motion of the flames to control the placement of soot along the release coating. Rotational motion of the bait substrate with release coating facilitates uniformity of soot deposition in the angular direction of bait substrates having round shapes or curved surfaces. Relative translational motion of the bait substrate with release coating formed thereon and the one or more burners provides broad area coverage and promotes uniformity of soot deposition in the axial direction along the bait substrate. Soot may be formed directly from soot precursors on the release coating. Alternatively, soot may be formed independent of the release coating and applied to the release coating by a soot pressing process to form a porous soot body.

Upon conclusion of the soot deposition process, a porous soot body has been formed. The porous soot body remains attached to the bait substrate and is next separated from the bait substrate. As noted hereinabove, the release coating may be depleted during soot deposition to weaken the attachment of the porous soot body to the bait substrate. The depletion may be the result of a decomposition, oxidation, or sublimation process. The release coating may also consist of a brittle material. Separation of the porous soot body from the bait substrate may occur through application of mechanical force. The bait substrate may be pulled and/or twisted to effect separation from the porous soot body. Because of the weak mechanical strength of the release coating separating the bait substrate and porous soot body, only limited mechanical force is needed to effect separation. The separation force needed is sufficiently low to enable removal of the bait substrate without fracturing or otherwise damaging the porous soot body.

Upon separation, a porous soot body independent of the bait substrate remains. The porous soot body includes an internal cavity corresponding to the space formerly occupied by the bait substrate. The separated porous soot body may be further processed. In one embodiment, the separated porous soot body is consolidated to form a core cane. The consolidation may include dehydration to remove water and hydroxyl groups and sintering to collapse pores. Dehydration is accomplished by exposing the separated porous soot body to a dehydration agent (e.g. Cl₂, CO, SiCl₄, SOCl₂). Dehydration is performed at a temperature below the temperature to initiate sintering and densification of the separated porous soot body. The pore structure of the separated porous soot body facilitates dehydration by permitting penetration of the dehydration agent into the interior of the porous soot body. More complete dehydration results. Typical dehydration temperatures are in the range from about 600° C. to about 1300° C. Sintering occurs at temperatures above about 1300° C. and induces compaction of the separated porous soot body via collapse of the pore structure to provide a fully densified glass body. The densified glass body can be used as a core cane in the manufacture of optical fiber preforms. To form the optical fiber preform, one or more soot cladding layers is formed on the core cane and additional dehydration and sintering processes are performed to densify the cladding and fuse it to the consolidated core cane. An optical fiber may be formed from the optical fiber preform using techniques known in the art.

In another embodiment, the separated porous soot body may be used as a cladding in a cane-in-soot process for making optical fiber preforms. In this application, the separated porous soot body constitutes a porous soot cladding that can be consolidated and fused to a densified core cane. The separated porous soot body acts as a “sleeve” and a pre-manufactured consolidated core cane is inserted into the internal cavity present in the separated porous soot body to form a core-cladding assembly that can be further processed to form an optical fiber preform. The core-cladding assembly includes a consolidated core cane surrounded by a porous soot cladding (the separated porous soot body). A gap is present between the consolidated cane core and porous soot cladding. The core-cladding assembly can be dehydrated by exposing it to a dehydrating agent. The dehydrating agent can enter the gap between the consolidated cane core and porous soot cladding and can further penetrate the pore structure of the porous soot cladding to remove water and hydroxyl groups. The dehydrating agent can also be supplied to the outside surface of the porous soot cladding to remove water and hydroxyl groups. The dehydrated core-cladding assembly may be sintered to provide a densified optical fiber preform. An optical fiber may be formed from the optical fiber preform using techniques known in the art.

In another aspect of the cane-in-soot process, the core-cladding assembly can also be exposed to a reducing agent. The reducing agent can be provided after dehydration. The reducing agent can be provided before and/or during sintering. The reducing agent may be supplied as a gas that enters the gap between the consolidated cane core and porous soot cladding as well as the pores of the porous soot cladding. Exposure of the core-cladding assembly to a reducing agent leads to a reduction in oxygen-rich defects (e.g. peroxy defects, non-bridging oxygen hole center defects) in the cladding of the optical fiber preform as well as in fibers drawn from the preform. Representative reducing agents include CO, SiCl₄, and CH₄. The temperature of exposure of the core-cladding assembly to the reducing agent may be a temperature above 1050° C., or a temperature above 1100° C., or a temperature above 1150° C., or be a temperature above 1200° C., or a temperature above 1250° C., or a temperature above 1300° C., or a temperature between 1000° C. and 1300° C., or a temperature between 1050° C. and 1250° C.

In one embodiment, deposition of the release coating onto the bait substrate and deposition of soot to form the porous soot body occur in different systems. The release coating is formed on the bait substrate in a first deposition system, the bait substrate with release coating is removed from the first deposition system and placed in a second deposition system, and the porous soot body is formed in the second deposition system. Advantages of using separate deposition systems for formation of the release coating and the porous soot body include: (1) improved utilization of the lathe used for soot deposition through transfer of the release coating process to an offline process; (2) better process control and consistency in the deposition of the release coating through use of a dedicated system optimized for formation of the release coating; (3) greater flexibility in customizing the properties of the release coating (e.g. thickness, uniformity, positions of coverage on bait substrates); and (4) avoidance of contamination of unutilized soot generated in the soot deposition process with impurities from the precursors used to form the release coating. Stock inventory of release coating-coated bait substrates can be produced in a deposition system dedicated to release coating formation and reserved until needed for soot deposition. Since the time needed for deposition of the release coating is often a significant fraction of total process time, the availability of bait substrates with pre-fabricated release coatings is advantageous. Since the process time needed to deposit the porous soot body is relatively short, the availability of bait substrates with pre-fabricated release coatings decreases turnaround time in meeting market demands.

### Example 1

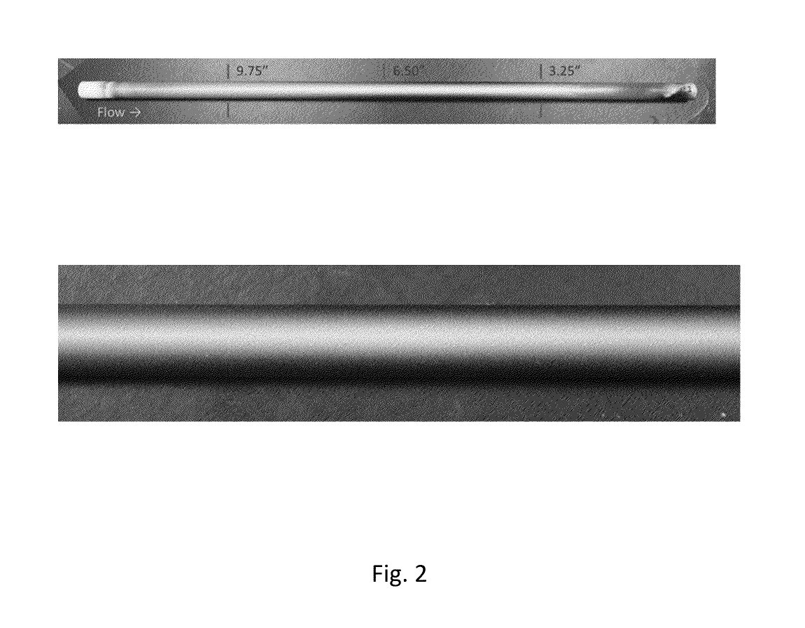

In this example, a carbon release coating was formed on an alumina bait substrate using a pyrolytic process. The alumina bait substrate was in the form of an alumina bait rod and was coated with carbon deposited from the pyrolytic decomposition of a carbon-containing feedstock. The carbon-containing feedstock was a mixture of 50% (by volume) methane in an inert gas (argon or helium). The carbon-containing feedstock was flowed over the alumina bait rod at 100 sccm at 1100° C. for 1 hour to form a carbon release coating. FIG. 2 shows the bait rod with a carbon release coating formed using argon as the inert gas after conclusion of the process. The upper image shows the coated bait substrate and the lower image is a close up view that shows the quality of the release coating. The release coating was 10-20 μm thick and was uniform along the length of the bait rod. It was noted that the quality of the carbon release coating was better when argon was used as the inert gas than when helium was used as the inert gas. The pyrolytic deposition process is readily scalable to bait substrates of any length and multiple bait substrates can be coated simultaneously with a release coating in the deposition system.

### Example 2

In this example, a carbon release coating is formed on alumina bait rods by a dip coating process. The dip-coating process consisted of immersing a bait substrate into a coating medium and withdrawing it at a controlled rate. The dip coating process can apply coatings that are a few microns thick in a single dipping cycle and is well-suited for coating graphite onto alumina bait rods.

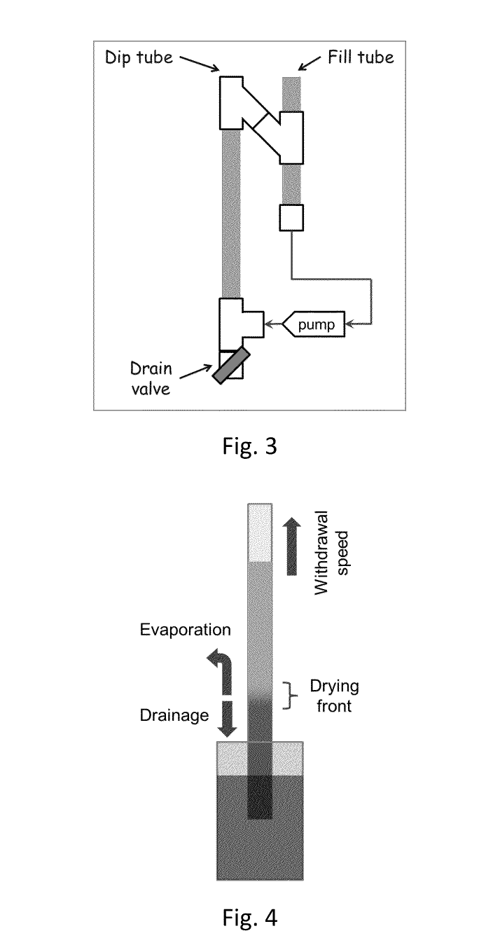

An apparatus for providing a release coating is shown in FIG. 3. The primary components of the dip coating apparatus are a dip tube, a fill tube, a pump, and a drain valve. The coating medium is supplied to the fill tube and pumped into the dip tube to form a reservoir of coating medium. The pump also recirculates the coating medium to maintain uniformity. The bait substrate is inserted at the top of the dip tube, lowered to a desired depth in the reservoir of coating material, and then withdrawn. The release coating forms as the solvent evaporates from the surface of the bait substrate.

The thickness of the release coating is controlled by two factors: the evaporation rate of the solvent and the drainage rate of the coating medium from the surface of the bait substrate. The solvent evaporation rate can be influenced by the choice of solvent (higher vapor pressure=faster evaporation rate) and the temperature above the reservoir (higher temperature=faster evaporation rate). The rate of drainage is mainly influenced by the viscosity of the coating medium (higher viscosity=slower drainage). Thicker coatings are generally achieved with a coating medium having a high evaporation rate and a high viscosity.

Solvent and drainage rate also determine the optimal withdrawal speed of the bait substrate from the reservoir of coating medium (FIG. 4). As the substrate is pulled out of the reservoir of coating medium, a drying front is established. The coating is dry above the drying front and remains liquid below the drying front. If the withdrawal of the bait substrate is too fast, the excess coating medium does not have enough time to drain from the surface of the bait substrate and dries before it can return to the reservoir. In this case, the drying front would move upward along the bait substrate (in the direction away from the reservoir) over time and the thickness of the resulting coating of release coating would increase from top to bottom along the bait substrate. If the withdrawal of the bait substrate is too slow, most of the coating medium drains from the surface of the bait substrate. Although the resulting coating of release coating would be uniform, it would also be very thin and long periods of time would be required to obtain coatings of reasonable thickness. The optimum withdrawal speed is one in which the drying rate of the coating medium balances the rate of drainage so that the drying front remains stationary (typically just a few inches above the top of the reservoir) so that the thickness of the resulting release coating is uniform along the length of the substrate and the rate of deposition of the release coating is reasonably high.

In a typical coating operation, the surface of the bait substrate is cleaned with a solvent (e.g. isopropanol) and the sections of the bait substrate that do not require coating are covered with tape (e.g. masking tape or PTFE tape). One end of the bait substrate is then mounted onto a mechanical slide and lifted above the reservoir of coating medium. After checking the alignment, the bait substrate is lowered into the reservoir until the target height of the release coating is reached. The bait substrate is then withdrawn from the reservoir at a speed in the range from 1-20 mm/sec until it is completely out of the dip coating apparatus. The bait substrate is then removed from the slide and the coating is allowed to cure. The tape is then removed from the masked sections and the bait substrate with release coating rod is ready for transfer to a soot deposition unit.

Coating media capable of providing a carbon release coating typically include a carbon precursor, a binder, and a solvent. The carbon precursor is an insoluble solid and is suspended in the solvent. The carbon precursor may be particulate carbon-containing solid such as graphite or carbon black. The particle size of the carbon precursor influences the processing of the coating medium and the characteristics of the release coating. If the particle size of the carbon precursor is too large, the carbon particles have a tendency to settle to the bottom of the coating reservoir and uniformity of the coating medium is compromised. Large carbon particles, however, exhibit better cohesion, provide for a more durable release coating (one that is less resistance to scratching) and can be loaded at higher concentration in the solvent. Higher carbon precursor loading leads to higher viscosity of the coating medium and thicker coatings of release coating (for a single dipping cycle). Smaller carbon particles are more buoyant and less prone to settling over time, but are less cohesive (thus necessitating the need for high binder concentration) and require more process time (longer dip cycle or multiple dip cycles) to achieve release coatings of a given thickness because they cannot be loaded at high concentrations into the solvent.

In one embodiment, the carbon precursor contains carbon particles having an average size in the range from 1-50 In another embodiment, the carbon precursor contains carbon particles having an average size in the range from 2-25 In still another embodiment, the carbon precursor contains carbon particles having an average size in the range from 5-20 Graphite is a representative carbon precursor having micron-scale carbon particles.

The carbon precursor may also include carbon particles or carbon-containing particles having an average size in the range from 1-50 μm, or 2-25 μm, or 5-20 μm, or 10-100 nm, or 25-75 nm, or 40-60 nm, or 10-1000 nm, or 20-500 nm, or 50-250 nm, or less than 1 μm, or less than 500 nm, or less than 100 nm. Carbon black is a representative carbon precursor having nanoscale carbon particles. The carbon precursor may also include a combination of micron-scale carbon particles (e.g. graphite) and nanoscale carbon particles (e.g. carbon black). As used herein, average particle size refers to the average size of all particles in the carbon precursor and not to a subset of all particles.

To avoid contamination of the porous soot body, it is preferable to use a carbon precursor with high purity. The carbon precursor may consist essentially of carbon and/or carbon particles and/or graphite and/or carbon black.

The binder promotes uniformity of the coating medium by aiding dispersal of the carbon precursor in the solvent. The binder also promotes adhesion between the release coating and bait substrate as well as internal adhesion of the release coating. The binder also influences the viscosity of the coating medium.

Binders derived from natural sources (such as cellulose-based binders) often include impurities. To minimize such impurities, it is preferably to use the minimum amount of binder necessary to achieve adequate adhesion of the carbon release coating to the bait substrate and adequate internal cohesion of the carbon release coating. To achieve this objective, the ratio (in units of wt %) of carbon precursor to binder may be at least 5:1, or at least 10:1, or at least 15:1, or at least 20:1.

The viscosity of the coating medium is also influenced by the choice of solvent. The volatility of the solvent (e.g. vapor pressure) influences the evaporation rate of the coating medium. Co-solvents may also be included to promote dissolution of the binder. Representative solvents and co-solvents include alcohols such as propanol and butanol or alkoxy-substituted alcohols (e.g. 1-methoxy-2-propanol). Alcohols and alkoxy-substituted alcohols provide adequate solubility for cellulose-based binders.

Cellulose-based binders include cellulose and substituted cellulose compounds. In one embodiment, the cellulose-based binder is a substituted cellulose compound, where substitution occurs at one or more hydroxyl positions of cellulose and converts the hydroxyl group (—OH) to an alkoxy group (—OR, where R is an alkyl group or other organic group). R may, for example, be a methyl group, or an ethyl group, or a propyl group, or a butyl group, or an acetate group, or a propionate group, or a butanoate group. The substituted cellulose compound may include substitution by one or more R groups. Cellulose-based binders may be incorporated in the coating medium as neat compounds or may be diluted in a solvent to control viscosity. The solvent may be an aromatic compound or an alcohol or a combination of an aromatic compound and an alcohol. In one embodiment, the solvent is a mixture of toluene and an alcohol (e.g. methanol, ethanol, propanol, or butanol). In one embodiment, the binder is an alkyl-substituted cellulose (which may also be referred to herein as an alkyl cellulose compound or a cellulose ether) in a mixed aromatic-alcohol solvent, such as, for example, ethyl cellulose in a mixed toluene-ethanol solvent. Representative cellulose-based binders include ethyl cellulose and cellulose acetate butyrate.

In one embodiment, the coating medium includes 5-30 wt % carbon precursor, 0.10-2.0 wt % binder, and 50-95 wt % combined of solvents and co-solvents. In another embodiment, the coating medium includes 5-30 wt % graphite, 0.10-2.0 wt % cellulose-based binder, and 50-90 wt % combined of one or more alcohol or alkoxy-substituted alcohol solvents or co-solvents. In still another embodiment, the coating medium includes 5-30 wt % graphite, 0.10-2.0 wt % ethylcellulose binder, and 50-95 wt % combined of one or more of isopropanol, butanol, and 1-methoxy-2-propanol.

In one embodiment, the coating medium includes 5-30 wt % graphite, 0.10-2.0 wt % ethylcellulose binder, and 50-95 wt % isopropanol. In another embodiment, the coating medium includes 10-30 wt % graphite, 0.10-2.0 wt % ethylcellulose binder, at least 50 wt % isopropanol, and at least 2 wt % of an alcohol or alkoxy alcohol other than isopropanol. In still another embodiment, the coating medium includes 10-30 wt % graphite, 0.10-2.0 wt % ethylcellulose binder, 60-80 wt % isopropanol, at least 1 wt % of an alcohol other than isopropanol, and at least 1 wt % of an alkoxy alcohol. In yet another embodiment, the coating medium includes 10-30 wt % graphite, 0.10-2.0 wt % ethylcellulose binder, 60-80 wt % isopropanol, and 3-7 wt % butanol. In a further embodiment, the coating medium includes 10-30 wt % graphite, 0.10-2.0 wt % ethylcellulose binder, 60-80 wt % isopropanol, and 3-7 wt % butanol., and at least 1 wt % of an alkoxy alcohol. In an additional embodiment, the coating medium includes 10-30 wt % graphite, 0.10-2.0 wt % ethylcellulose binder, 60-80 wt % isopropanol, and 3-7 wt % butanol., and at least 1 wt % of 1-methoxy-2-propanol.

To prepare the coating medium, the solvent (and optional co-solvent(s)) are weighed and placed into a receiving vessel. The carbon precursor and binder are weighed separately and lightly mixed to prevent clumping of the binder when the mixture is added to the solvent. The mixture is then added to the solvent in the receiving vessel. Pieces of grinding media (e.g. ½″×½″ alumina) are added to the receiving vessel to facilitate dissolution of the binder and break up agglomerates. The receiving vessel is then closed with a lid and placed on a rolling mill for an extended period of time. To counteract any settling that may occur over time, the receiving vessel is agitated shortly before use in the dip coating apparatus.

A series of coating formulations was prepared and applied to alumina bait rods to form carbon release coatings. The compositions of the formulations are listed in Tables I & II below:

TABLE I
Coating Formulations (wt %)

| | 1 | 2 | 3 | 4 | 5 | 6 | 7 | 8 | 9 |
|---|---|---|---|---|---|---|---|---|---|
| isopropanol | 90 | 90 | — | 80 | 78 | 80 | 83 | 80 | 80 |
| n-butanol | — | — | — | 5.0 | 4.9 | 5.0 | 5.9 | 5.0 | 5.0 |
| PGME | — | — | — | 5.0 | 4.9 | 5.0 | 5.9 | 5.0 | 5.0 |
| cyclohexanol | — | — | 44 | — | — | | — | — | — |
| acetone | — | — | 44 | — | — | | — | — | — |
| graphite 2-15 μm | 10 | 10 | 10 | 10 | 10 | 10 | — | 10 | 8.0 |
| carbon black | — | — | — | — | — | — | 5.0 | — | 2.0 |
| EC-10 | — | — | — | — | — | — | — | 0.50 | — |
| EC-22 | 1.0 | — | — | — | 2.5 | 0.50 | 0.25 | — | 0.50 |
| EC-300 | — | 1.0 | — | 0.50 | — | — | — | — | — |
| Cellulose acetate | | | 1.0 | — | — | — | — | — | — |

TABLE II
Coating Formulations (wt %)

| | 10 | 11 | 12 | 13 | 14 | 15 | 16 |
|---|---|---|---|---|---|---|---|
| isopropanol | 83 | 78 | 69 | 78 | 78 | 78 | 82 |
| n-butanol | 5.9 | 5.7 | 5.0 | 5.7 | 5.7 | 5.7 | 5.9 |
| PGME | 5.9 | 5.7 | 5.0 | 5.7 | 5.7 | 5.7 | 5.9 |
| graphite 2-15 μm | 5.0 | 10 | 20 | — | — | 10 | — |
| graphite 0.25-5 μm | — | — | — | 10 | — | — | — |
| graphite 0.1-10 μm | — | — | — | — | 10 | — | — |
| carbon black | — | — | — | — | — | — | 6.0 |
| EC-22 | 0.25 | — | — | — | — | — | — |
| EC-300 | — | 0.50 | 1.0 | 0.50 | 0.50 | — | 0.30 |
| CAB-553-0.4 | — | — | — | — | — | 0.50 | — |

Graphite and carbon black are carbon precursors. The graphite was obtained from Alfa-Aesar and had an average carbon particle size in the range, as listed, from 2-15 μm, 0.25-5 μm, or 0.1-10 Carbon black, also referred to as acetylene black, was obtained from Alfa-Aesar (product no. 39724) and had an average carbon particle size of 42 nm. EC-10, EC-22, EC-300, cellulose acetate, and CAB-553-0.4 are binders. EC-10, EC-22 and EC-300 are different grades of ethylcellulose binder obtained from Sigma-Aldrich (Product Nos. 200689, 200697 and 200546, respectively). EC-10, EC-22 and EC-300 each have 48% ethoxyl labelling. The different grades of ethylcellulose binder reflect different molecular weights. EC-10 has a lower molecular weight than EC-22, which has a lower molecular weight than EC-300. CAB-553-0.4 is cellulose acetate butyrate and was obtained from Eastman Chemical Co. Isopropanol is a solvent. 1-butanol is a co-solvent. PGME (1-methoxy-2-propanol, also known as polyethylene glycol methyl ether) is a co-solvent. The solvents and co-solvents are available from numerous vendors, including Fisher, Alfa Aesar, and Sigma-Aldrich.

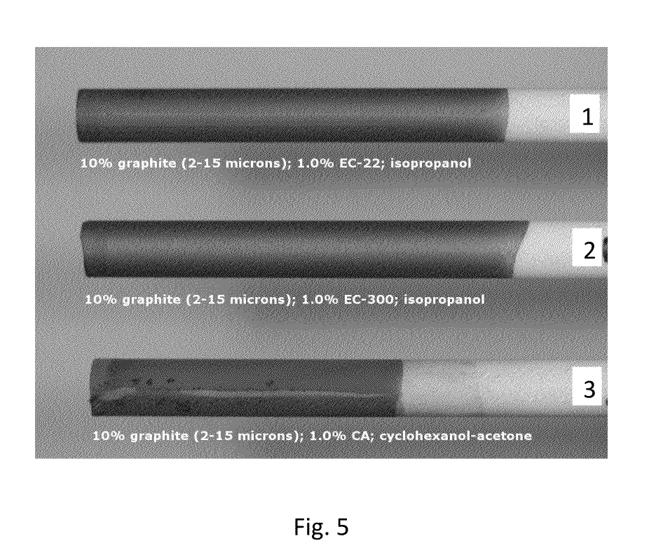

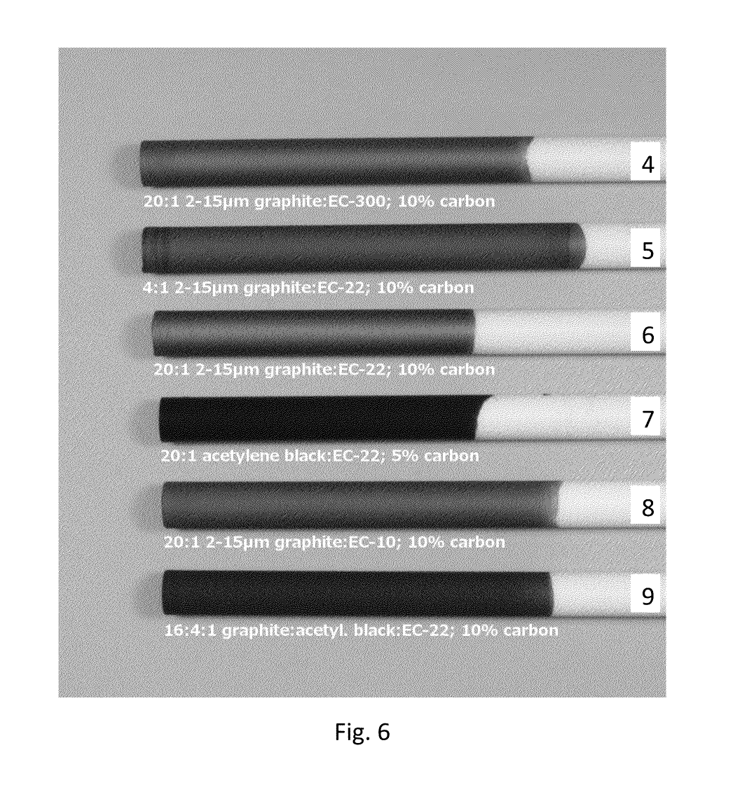

Each formulation was applied to an alumina bait rod using a dip coating apparatus of the type shown in FIG. 3. The formulations were applied to provide a carbon release coating with a target thickness of 10-20 μm on each bait rod. The rate of withdrawal from the reservoir of coating formulation was 1-20 mm/s. Samples of coated bait rods are shown in FIGS. 5 and 6. Each bait rod is labeled with the number of the coating formulation (from Table 1) used to obtain the carbon release coating. The carbon release coating corresponds to the dark coating extending from the left along the bait rod. Coating thickness was measured at selected positions along the bait rods and was found to be ˜13 μm. The sample bait rods demonstrate that high quality carbon release coatings can be deposited using the dip coating process.

Porous soot bodies were formed on selected bait substrates using a flame process and OMCTS (octamethylcyclotetrasiloxane) as the silica precursor. The durability of the carbon release coating on the bait rods was examined by observing the release coating during the early stages of soot deposition as the flame traversed the bait rod to form the initial layers of silica soot on the release coating. The release coating is subjected to the most extreme temperatures at the outset of the soot deposition process and becomes insulated as the thickness of the soot increases and the deposition front becomes further removed from the bait rod. The integrity of the carbon release coating was maintained during the first few passes of the burner flame and formation of the porous soot body was successfully accomplished.

After formation of the porous soot body, the bait rods were manually pulled to separate the porous soot body from the bait rod. Only modest force was required to remove the bait rod and the surface of the removed bait rod was clean with little or no residual carbon. After removal of the bait rod, two separated porous soot bodies were integrated with core canes to form core-cladding assemblies, which were consolidated in a cane-in-soot process. A smaller porous soot body was integrated with a smaller core cane to form a smaller core-cladding assembly. A larger porous soot body was integrated with a larger core cane to form a larger core-cladding assembly. Cane-in-soot consolidation of the smaller core-cladding assembly included passage of a dehydrating gas in the space between the outer surface of the core cane and the inner surface of the porous soot body. Both core-cladding assemblies were fully consolidated to form fiber preforms. The visual quality of the preforms was excellent and comparable to typical preforms used in fiber manufacturing. Fiber was drawn from the smaller preform. The drawn fiber was uniform in diameter and exhibited no visible airline or seed defects. The level of attenuation observed for the fiber was comparable to standard commercial fiber and demonstrated that the carbon release coating included in the preform production process had no apparent negative impact on the quality of fiber.

One potential concern about the release coating was whether residue from the release coating would remain on the inner surface of the porous soot body after separation of the bait substrate. Such residue would exist at the interface of the core cane and porous soot body in the cane-in-soot assembly and might potentially constitute a source of mechanical weakness in the fiber preform formed after consolidation as well as in fibers drawn from the preform. To investigate the concern, the fiber drawn from the cane-in-soot preform was screen tested at 100 kpsi to assess strength. Although the fiber broke, analysis of the break ends by BSA (break source analysis) revealed that the locations of the break points were at the fiber surface and not at the core-cladding interface. This indicates that breakage was not caused by residue from the release coating and that some factor unrelated to the release coating was responsible for mechanical failure.

### Example 3

In this example, a carbon release coating is formed on alumina bait rods using a spray coating process. The spray coating process involves rotating a bait rod while translating a spray gun along the length of the bait rod to apply a coating medium to the bait rod to deposit the release coating. The spray gun is air- or gas-driven and applies the coating medium as a liquid spray or fine mist to the bait rod.

The coating medium for the spraying process can be a suspension-based formulation containing a carbon precursor material. Coating formulations used for dip coating processes (including formulations described in Example 2 hereinabove) are generally suitable as coating media in the spray coating process. Alternatively, the coating medium for a spray coating process may include an organic polymer carbon precursor, such as a phenolic resin, that is subsequently reduced to carbon to provide a release coating. The characteristics such as concentration of carbon precursor material, viscosity, and drying rate can be adjusted by adding more solvent (e.g. isopropanol) or compatible co-solvents (e.g. butanol, PGME, terpineol) to adjust the carbon release coating characteristics to meet the requirements of the spraying system while providing a high quality carbon release coating.

The thickness and uniformity of the carbon release coating is a function of the carbon concentration of the material being deposited, spray gun flow settings, bait rod rotation speed, spraying speed, and the number of passes along the target coating length. The spray process can be used to deposit carbon coatings that are uniform in thickness or varying in thickness along the bait rod length (taper, sinusoidal thickness variation, etc.) by adjusting the parameters above. Carbon thicknesses can range from a few micrometers to >100 micrometers.

Experiments were performed to form carbon release coatings on alumina bait rods. The carbon release coatings were deposited using coating formulations of the type described in Example 2 hereinabove for dip coating processes. One formulation was a commercial graphite paint available from SPI Supplies (Product No. 05006-AB). Another formulation included 19.8 wt % graphite (average particle size 2-15 μm), 0.85 wt % EC-300 ethylcellulose binder, 72.2 wt % isopropanol, 5.0 wt % 1-butanol, and 5.0 wt % PGME. Both formulations (which are also suitable for the dip coating process) provided high quality carbon release coatings in a spray coating process.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the illustrated embodiments. Since modifications, combinations, sub-combinations and variations of the disclosed embodiments that incorporate the spirit and substance of the illustrated embodiments may occur to persons skilled in the art, the description should be construed to include everything within the scope of the appended claims and their equivalents.

What is claimed is:

1. A method for forming a porous soot body comprising:
placing a bait substrate in a first deposition system;
forming a release coating on said bait substrate;
transferring said coated bait substrate from said first deposition system to a second deposition system; and
depositing soot on said coated bait substrate in said second deposition system.

2. The method of claim 1, wherein said bait substrate is tapered.

3. The method of claim 1, wherein said release coating comprises carbon.

4. The method of claim 3, wherein said soot comprises silica.

5. The method of claim 1, wherein said release coating is formed by dip coating.

6. The method of claim 5, wherein said dip coating comprises applying a liquid coating medium to said bait substrate.

7. The method of claim 5, wherein said liquid coating medium comprises a carbon precursor.

8. The method of claim 7, wherein said carbon precursor comprises carbon particles, said carbon particles having an average particle size in the range from 1-50 μm.

9. The method of claim 6, wherein said liquid coating medium comprises 5-30 wt % carbon precursor, 0.10-2.0 wt % binder, and 50-95 wt % solvent.

10. The method of claim 1, wherein said second deposition system includes a flame, said flame combusting a soot precursor to form said soot.

11. The method of claim 10, wherein said soot comprises silicon and said soot precursor comprises a silica precursor.

12. The method of claim 11, wherein said silica precursor is octamethylcyclotetrasiloxane or SiCl₄.

13. The method of claim 11, wherein said soot formed by said flame includes a utilized portion and an unutilized portion, said utilized portion depositing on said release coating and said unutilized portion not depositing on said release coating.

14. The method of claim 13, further comprising recovering said unutilized portion of said soot from said second deposition system, said recovered unutilized soot lacking contamination from said release coating.

15. The method of claim 14, wherein said release coating comprises carbon and said recovered unutilized soot lacks carbon contamination.

16. The method of claim 10, wherein said depositing soot includes forming a porous soot body on said release coating.

17. The method of claim 16, further comprising separating said bait substrate from said porous soot body, said separated porous soot body including an internal cavity.

18. The method of claim 17, further comprising forming a core-cladding assembly, said forming core-cladding assembly including inserting a core cane in said internal cavity of said separated porous soot body.

19. The method of claim 18, further comprising dehydrating said core-cladding assembly.

20. The method of claim 19, further comprising delivering a reducing agent to said core-cladding assembly, said reducing agent passing through the space between said core cane and said separated porous soot body.
